(19) United States
(12) Patent Application Publication
(10) Pub. No.: US 2013/0279734 A1
(43) Pub. Date: Oct. 24, 2013

(54) Acoustic Transducer Basket

(71) Applicant: KNOWLES ELECTRONICS ASIA PTE. LTD., Singapore (SG)

(72) Inventors: Erich Klein, Himberg (AT); Thomas Pauser, Vienna (AT); Michael Schöffmann, Siegenfeld (AT)

(73) Assignee: Knowles Electronics Asia PTE. Ltd., Singapore (SG)

(21) Appl. No.: 13/865,888

(22) Filed: Apr. 18, 2013

Related U.S. Application Data
(60) Provisional application No. 61/635,775, filed on Apr. 19, 2012.

(51) Int. Cl. H04R 1/02

(52) U.S. Cl. CPC H04R 1/02
USPC 381/395

(57) ABSTRACT

An acoustic transducer assembly with a basket for receiving and electrically contacting an acoustic transducer, the basket being configured to be mounted on, and electrically connected to, a platform, such as a printed circuit board, or a support or a housing. The basket may include electrical contact areas for electrically connecting the basket to the platform, and at least one mounting structure for cooperating with a platform-sided mounting structure to form a fixed mechanical connection with the platform. An electrical contact area of the basket may be integrally formed with the mounting structure of the basket.

### FIELD OF THE INVENTION

The invention relates to an acoustic transducer basket for receiving and electrically contacting an acoustic transducer to an acoustic transducer assembly, and to a communication device, particularly a cellular phone.

### BACKGROUND OF THE INVENTION

In the course of miniaturization of communication devices, particularly cellular phones, the acoustic transducers assembled in these devices became smaller and smaller. Particularly, the electrical contacting of miniaturized loudspeakers with the device became a great challenge.

German Publication No. DE19737134A1 relates to a card reading unit including an identity card inserted into a receiving space. Electric contacts are arranged within the receiving space, on its floor. They contact with corresponding contacts on the identity card. The card carrier is made of non-galvanized plastic, whereby contact bodies of the electric contacts consist of galvanized plastic, embedded partially in the card carrier and having galvanized free surface areas. A spring element made from an elastic plastic is provided on the inside of the fastener arrangement. This document, however, does not relate to the problem of how to contact the card carrier.

In contrast, the contacting of acoustic transducers is much more complex and is of a different kind. Usually, loudspeakers are accommodated in a basket, enclosing or surrounding the active elements of the loudspeaker, in particular the coil, coil wires, membrane, and their mechanical supports. In order to contact the coil of the speaker with a printed circuit board, separate connection elements have so far been employed. In the prior art, connection elements in the form of extremely small metal springs are known. When assembling the loudspeaker with the basket, the metal springs are inserted into recesses provided in the basket. In the assembled state, a contact area of the metal springs is accessible from outside. The contact areas of the metal spring are pressed against corresponding contacts on the printed circuit board, thus establishing an electrical connection. It is necessary to have a separate mounting for establishing a fixed mechanical connection between the basket and the printed circuit board.

The assembling process including the step of establishing an electrical contact between basket and PCB by aligning the springs to the electrical contacts of the PCB, and an additional step of mechanically fixing the basket to the PCB, is extremely complex, time-consuming, and very costly.

### SUMMARY OF THE INVENTION

In aspects, the invention relates to the contexts of overcoming the problems of the prior art and of providing baskets for receiving and electrically contacting miniaturized acoustic transducers, the baskets having a reliable electrical contact mechanism with corresponding external contacts of a platform, for example on a printed circuit board. At the same time, the mechanical connection between basket and platform should be reliable. In contrast to the prior art, the production of such baskets as well as of acoustic transducer assemblies should be cost-effective and time-saving.

The acoustic transducer basket receives and electrically contacts an acoustic transducer, the basket being configured to be mounted and electrically connected to a platform, for example a printed circuit board, a support, or a housing, wherein the basket includes: electrical contact areas for electrically connecting the basket to the platform, and at least one mounting structure for cooperating with a platform-sided mounting structure to form a fixed mechanical connection with the platform; wherein an electrical contact area of the basket is integrally formed with the mounting structure of the basket.

With such a miniaturized basket, the electrical connection between basket and platform may be established directly via the mounting mechanism. The same mounting mechanism forming a fixed mechanical connection between basket and platform also forms the electrical connection between basket and platform. A reliable mechanical connection thus also implies a reliable electrical connection, one that is insensitive to mechanical impacts, forces, and vibrations. The present solution allows a cost-effective and time-saving production and assembly of the basket to a platform. In principle, the basket only has to be mechanically mounted to the platform, and the electrical connection is automatically established.

The platform may be any support structure for holding the basket, such as a printed circuit board (PCB), sometimes also called printed wiring board (PWB), a support, a mounting base, a housing, etc. The acoustic transducer may be a speaker, receiver, vibrator, or a multifunctional device having two types of transducers.

The electrical contact areas formed on the basket for establishing an electrical connection with the platform are electrically connected with electrical contacts on the basket that electrically connect the acoustic transducer when received by the basket. The electrical connection between the electrical contact areas and the electrical contacts for connecting the acoustic transducer may be formed, for example, by a metal plating provided on the basket.

In an embodiment, the electrical contact areas are formed on the bottom side of the basket and the electrical contacts for the acoustic transducer are formed on the top side of the basket. This allows a spatial separation between the mounting base, for example a PCB, and the electrical contacts for the acoustic transducer wires.

In an embodiment, the electrical connection between electrical contact areas and electrical contacts for the acoustic transducer extends on the outer face of the basket. Here, a metal plating may be easily applied from outside.

In an embodiment, the basket has an acoustic opening, and the electrical connection between electrical contact areas and electrical contacts for the acoustic transducer extends through the acoustic opening. Here, a metal plating would be efficiently protected in this area from mechanical stresses during production, assembly, and operation.

Preferably, the basket includes at least two mounting structures, wherein a first electrical contact area is integrally formed with a first mounting structure and a second electrical contact area is integrally formed with a second mounting structure. In this embodiment, first and second electrical contact areas, each of which is, for example, assigned to a different contact of the acoustic transducer, are integrally formed with mounting structures. This allows for a highly reliable mechanical connection between basket and platform via two pairs of cooperating mounting structures. Concurrently, different electrical contacts of the acoustic transducer basket may be assembled in one step.

Preferably, at least one mounting structure is arranged on a first side wall of the basket and at least one mounting structure is arranged on a second side wall of the basket, wherein preferably the second side wall is opposed to the first side wall. This allows for a high stability of the mechanical connection.

Preferably, each of the first and second side walls of the basket may include at least two mounting structures laterally spaced from each other. This further increases the mechanical stability.

Preferably, an electrical contact area is made from a metal plating, preferably a gold plating, forming a surface of the mounting structure. This measure ensures a reliable electrical connection of the basket with corresponding contacts on the platform, for example, on a printed circuit board. Concurrently, this solution is space-saving, which is an important requirement of miniaturized acoustic transducer assemblies. A gold plating is preferred due to the fact that, the electrical connection has to be of good quality for acoustic applications.

Since the thickness of the plating may be smaller than 100 μm, preferably smaller than 50 μm, most preferably smaller than 20 μm, this embodiment effects a space-saving solution. There are several techniques known in prior art to apply an electrically conducting plating on electrically non-conducting, particularly plastics material. Among them are PC/ABS (Polycarbonate/Acrylonitrile butadiene styrene) technique with two-shot process, the Futuron technology, or the PA (polyamide) technique for preparing the surface of plastic. This procedure is followed by electroplating or surface chemical plating with metals as, for example, copper (Cu) and/or nickel (Ni) and/or gold (Au). The total layer thickness may be, for example only 15 μm. The metal plating forms a rigid connection with the basket surface.

Preferably, an electrical contact area is formed by a piece of metal attached to a wall of the basket. This method allows to use the pieces of metals at the same time as mounting structures.

Preferably, a mounting structure includes a contact surface for engagement with the platform-sided mounting structure, wherein preferably the contact surface is a contact pad made of electrically conducting material. Such a contact surface may be engaged by means of the platform-sided mounting structure, for example a spring. In this embodiment the basket has passive mounting structures and the platform has active mounting structures, for example springs, capable of applying forces to the passive mounting structures.

Preferably, the contact surface is arranged in a recess of a side wall of the basket. The recess preferably facilitates the correct positioning and/or centering of the basket with respect to the platform. The active mounting structure of the platform (e.g., spring) is situated with its end in the recess of the basket. This further increases mechanical stability, and prevents the basket from being shifted in the mounted state.

Preferably, a mounting structure comprises at least one lateral projection, projecting laterally from a wall of the basket. This allows to mount the basket in a region laterally of the side wall thus reducing the mounting depth.

Preferably, at least on one side wall (most preferably on each of two opposing side walls) of the basket, at least two electrical contact areas are provided, wherein one of the electrical contact areas faces towards the top side of the basket and the other electrical contact area faces (in opposite direction) towards the bottom side of the basket, and wherein preferably one of the electrical contact areas is formed on a lateral projection of that side wall of the basket and the other electrical contact area is formed on a recess in the same side wall of the basket. This permits mounting of the acoustic transducer basket to the platform in two different ways; the transducer may be placed either in front of the platform or behind the platform. Usually, basket and acoustic transducer are configured such, that the membrane of the transducer is arranged at the top side of the basket. In a first possible mounting assembly the top side of the basket and thus the membrane faces towards the platform. In a second possible mounting assembly the bottom side of the basket faces towards the platform, wherein the membrane faces in opposite direction. In a present embodiment of an inventive basket, the basket may be mounted in two different ways, and is thus independent of the actual application used.

Preferably, electrical contact areas that are arranged on the same side wall of the basket may be electrically interconnected and assigned to the same contact of the acoustic transducer. This facilitates the use of the basket, since different mounting positions are possible without the need of changing the contact assignments between platform and basket.

Preferably, a mounting structure may include a spring projecting from the basket, wherein preferably the spring is a clip spring. In this embodiment, the active mounting structure is arranged on the basket, and the corresponding passive mounting structure, for example a hole, a recess, or a receptacle, is arranged on the platform.

Preferably, the basket may be made from molded plastic. Easy and cost-effective production methods such as injection molding may be used. The basket may thus be made from one piece.

The acoustic transducer assembly may include: a platform, for example a printed circuit board, a support, or a housing, having electrical contact areas; an acoustic transducer basket according to one of the embodiments previously described above, the acoustic transducer basket being mounted to the platform; and, an acoustic transducer accommodated and electrically connected by the basket; wherein the platform comprises at least one mounting structure cooperating with the mounting structure of the basket thereby forming a mounting mechanism, preferably a clip mechanism, providing a fixed mechanical connection between basket and platform; and, wherein an electrical contact area of the platform is integrally formed with the mounting structure of the platform, such that an electrical connection between an electrical contact area of the basket and an electrical contact area of the platform is established via the mounting mechanism.

As mentioned previously above in this description, the mechanical and electrical connection of the miniaturized acoustic transducer assembly are made via the same mechanism without the need to provide separate structures. This reduces costs and allows a time-saving assembly. As a result of reliable mechanical connection, a reliable electrical connection is also established.

In other words, the acoustic transducer assembly may include: a platform, for example a printed circuit board; a support or a housing, having electrical contact areas; an acoustic transducer basket mounted to the platform by a mounting mechanism, preferably a clip mechanism, the mounting having electrical contact areas for electrically connecting the basket to the electrical contact areas of the platform; and, an acoustic transducer accommodated and electrically connected by the basket; wherein the mounting mechanism includes at least one mounting structure on the basket cooperating with at least one mounting structure on the platform to form a fixed mechanical connection between basket and platform; and, wherein an electrical contact area of the basket is integrally formed with the mounting structure of the basket and an electrical contact area of the platform is integrally formed with the mounting structure of the platform, such that an electrical connection between an electrical contact area of the basket and an electrical contact area of the platform is established via the mounting mechanism.

Preferably, the basket includes at least two mounting structures. A first electrical contact area is integrally formed with a first mounting structure of the basket and a second electrical contact area is integrally formed with a second mounting structure of the basket. The mounting structures of the basket cooperate with corresponding mounting structures of the platform.

Preferably, at least one mounting structure is arranged on a first side wall of the basket and at least one mounting structure is arranged on a second side wall of the basket, wherein the second side wall is opposed to the first side wall, and wherein the mounting structures of the basket cooperate with corresponding mounting structures of the platform.

Preferably, a mounting structure of the basket comprises a contact surface and the mounting structure of the platform comprises an electrically conducting spring, the spring engaging the contact surface of the basket.

Preferably, the mounting mechanism is configured such, that the basket is pressed against the platform. This arrangement provides a high mechanical stability and a compact assembly.

Preferably, a mounting structure of the basket includes a contact surface, and the mounting structure of the platform includes an electrically conducting spring. The spring engages the contact surface of the basket. Here, the active (force-applying) mounting structure sits on the platform and the passive (force-receiving) mounting structure sits on the basket.

Preferably, a mounting structure of the basket includes two lateral projections, projecting laterally from a wall of the basket. The mounting structure of the platform is a bracket-shaped spring, each of its ends engaging with one of the lateral projections. In this arrangement, the two lateral projections, which are preferably spaced from each other, give increased mechanical stability. Such a platform-sided mounting structure, in form of a bracket-shaped spring, reliably engages both projections.

Preferably, the mounting structure of the basket includes at least one spring, preferably a clip spring, projecting from the basket towards the platform, and wherein the mounting structure of the platform, for example a receptacle, a hole, or a recess, fixes this spring in a clipped state. In this arrangement, the active (force-applying) mounting structure sits on the basket and the passive (force-receiving) mounting structure sits on the platform.

Preferably, the electrical contact areas of the platform are made of a metal plating, preferably a gold plating, forming a surface of the mounting structure.

Alternatively, the electrical contact areas of the platform are made by an attached piece of a metal.

In aspects, the invention may also relate to the context of a communication device, particularly a cellular phone comprising an acoustic transducer assembly according to at least one of the embodiments described above.

### BRIEF DESCRIPTION OF THE DRAWINGS

Further embodiments and aspects of the invention are indicated in the figures and in the remaining description. The invention will now be explained in a non-limiting manner by way of examples depicted in the drawings. In the exemplary drawings:

FIG. 1 depicts in top view a basket according to the invention.

FIG. 2 depicts in bottom view the basket of FIG. 1.

FIG. 3 depicts an acoustic transducer assembly with the basket of FIG. 1 mounted to a platform.

FIG. 4 depicts the acoustic transducer assembly of FIG. 3 in a cross section.

FIG. 5 depicts an acoustic transducer assembly with the basket of FIG. 1 mounted to a platform in inverse orientation with respect to FIG. 3.

FIG. 6 depicts the acoustic transducer assembly of FIG. 5 in a cross section.

FIG. 7 depicts a basket with springs.

FIG. 8 depicts an acoustic transducer assembly with the basket of FIG. 7 mounted to a platform.

FIG. 9 depicts a mobile phone including an acoustic transducer assembly.

### DETAILED DESCRIPTION OF THE INVENTION

In regard to the previous summary and as used in following, the phrases “in a/one embodiment,” “according to a/one embodiment,” and the like generally mean the particular feature, structure, or characteristic following the phrase is included in at least one embodiment of the present invention, and may be included in more than one embodiment of the present invention. Importantly, such phrases do not necessarily refer to the same embodiment. If the specification states a component or feature “may”, “can”, “could”, or “might” be included or have a characteristic, that particular component or feature is not necessarily required to be included or have the characteristic. Furthermore, as used throughout this specification, the terms “a”, “an”, “at least” do not denote a limitation of quantity, but rather denote the presence of at least one of the referenced item, and the term “a plurality” denotes the presence of more than one referenced items.

FIG. 1 depicts in top view an acoustic transducer basket 1 accommodating an acoustic transducer 2 in form of a loudspeaker. It should be understand that the invention is of course applicable to other miniaturized acoustic transducers. The basket 1, as such, may have rectangular shape and is thus formed with four walls. The four walls enclose an open space in which the acoustic transducer 2 may be accommodated. The membrane 15 of the acoustic transducer 2 is arranged at the top side of the basket 1 and may be seen from FIG. 1.

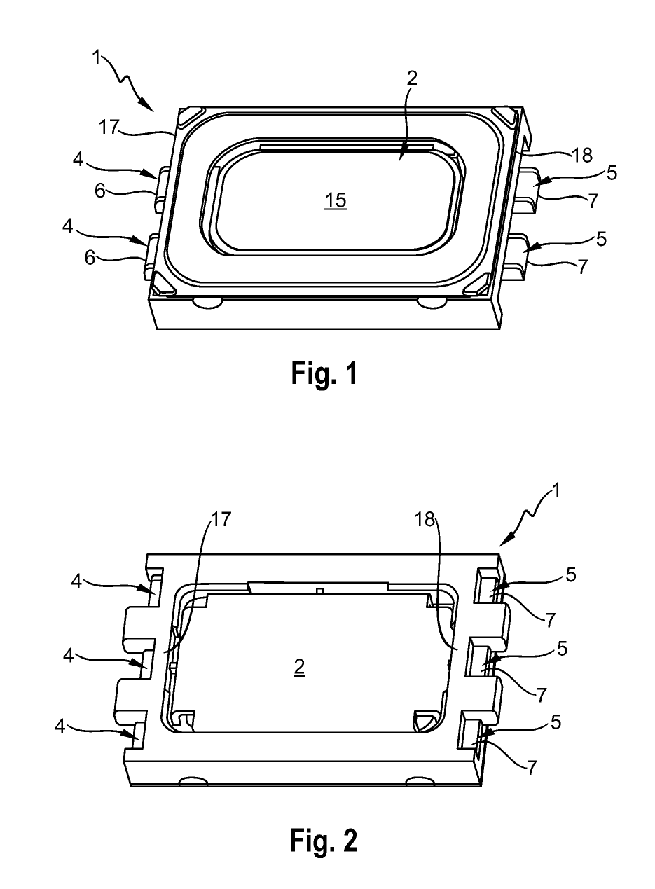

FIG. 2 depicts the same basket 1 in bottom view. Here, the bottom side of the acoustic transducer 2 may be seen, the bottom side being opposed to the membrane 15.

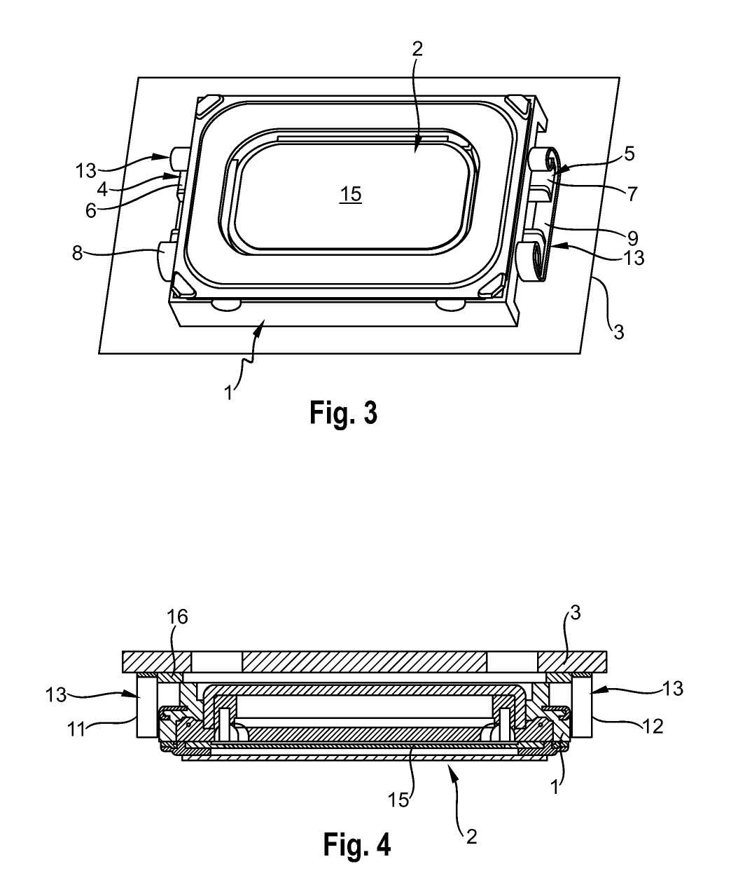

The acoustic transducer basket 1 includes on two opposed side walls 17, 18 electrical contact areas 4, 5 for electrically connecting the basket 1 to a platform 3 (see FIGS. 3-6).

First electrical contact areas 4 are integrally formed with first mounting structures 6, and second electrical contact areas 5 are integrally formed with second mounting structures 7. The first electrical contact areas 4 are assigned to a first electrical contact of the acoustic transducer 2, and the second electrical contacts 5 are assigned to a second electrical contact of the acoustic transducer 2 (for simplicity, electrical contacts of the transducer are not shown in the figures).

The mounting structures 6, 7 are configured to cooperate with corresponding platform-side mounting structures 8, 9 to form a fixed mechanical connection with the platform 3 (FIGS. 3-6).

The first mounting structures 6 are arranged on a first side wall 17 of the basket 1 and the second mounting structures 7 are arranged on a second side wall 18 of the basket 1, wherein the second side wall 18 is opposite to the first side wall 17.

As may be seen from FIGS. 1 and 3, each of the first and second side walls 17, 18 of the basket 1 comprises more than two electrical contact areas 4, 5—in the present embodiment five—which are integrally formed with contact surfaces for engagement with the platform-sided mounting structures 8, 9. The contact surfaces have the form of contact pads, and are made of, or covered by, electrically conducting material.

In the present embodiment, two of the respective electrical contact areas 4, 5 on the respective same side wall face towards the top side of the basket 1 (FIG. 1) and the other three respective electrical contact areas 4, 5 face towards the bottom side of the basket 1 (FIG. 2). The electrical contact areas facing upwardly are formed on lateral projections of that side wall (FIG. 1) and the other electrical contact areas facing downwardly are formed in recesses in the same side wall (FIG. 2).

In this embodiment, there are electrical contact areas facing in the same direction as the membrane 15 faces and electrical contact areas facing in the same direction as the back side of the transducer 2 faces. This allows mounting of the transducer 2 against the platform 3 in two different orientations, since electrical contact areas of different orientation of a side wall are assigned to the same electrical contact of the transducer 2.

The side-wall electrical contact areas 4, 5 as well as the electrical contact areas 11, 12 of the platform, may be formed by a piece of metal attached to a wall of the basket 1, the piece of metal being part of the corresponding mounting structure. This may be seen from the cross section of FIG. 6.

Alternatively, the electrical contact areas 4, 5 of the basket 1 and/or the electrical contact areas 11, 12 of the platform 3 may be made from a metal plating, preferably a gold plating, forming a surface of the mounting structures 6, 7 and/or mounting structures 8, 9.

The mounting structures on one side wall are preferably laterally spaced from each other, allowing a variant positioning of the basket 1 on the platform 3.

The basket 1, as shown in FIGS. 1 and 2, may be mounted to a platform 3 in different ways, increasing the flexibility already provided by the number of electrical contact areas on one side wall 17, 18. The platform 3 itself may include one or more sound outlet openings depending on the actual application.

A first mounting possibility is depicted in FIGS. 3 and 4. In this embodiment, the bottom side of the basket 1 faces towards the platform 3, and the top side of the basket 1 and the membrane 15 of the acoustic transducer 2 face in opposite direction. This kind of mounting is also called “back venting”, since the sound propagates from the membrane 15 in the direction of the bottom side (back side) of the transducer 2 towards a sound opening in the platform 3.

As previously mentioned above, the mounting structure on one side wall of the basket 1 includes two lateral projections, projecting laterally from a side wall of the basket 1. The corresponding mounting structure 8, 9 of the platform 3 may be a bracket-shaped spring 13, each of its ends engaging with one of the lateral projections. The arched end portions of the spring 13 allow a clipping of the basket 1 to the platform 3.

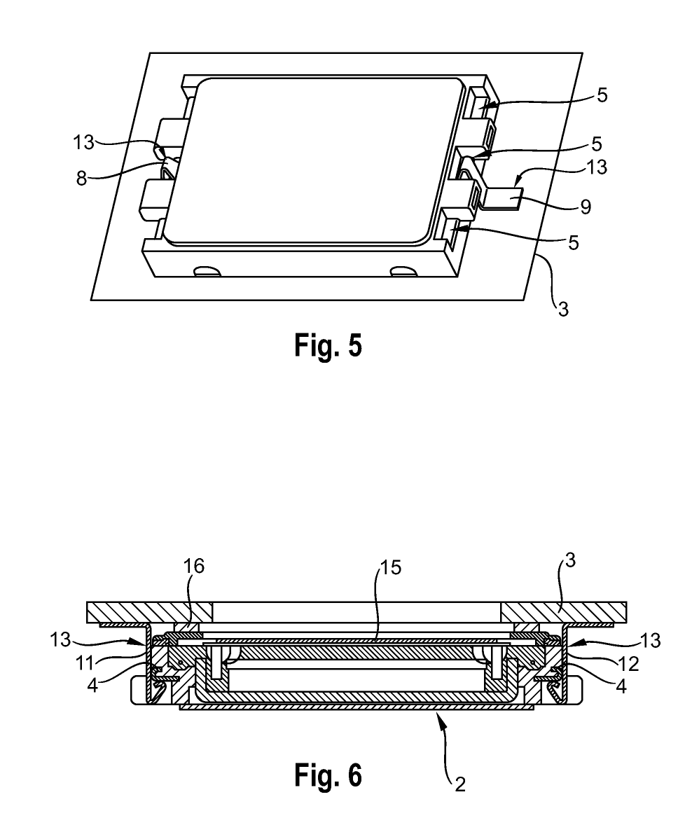

A second mounting possibility is shown in FIGS. 5 and 6. In this embodiment, the top side of the basket 1 and the membrane 15 of the acoustic transducer 2 face towards the platform 3, and the bottom side of the basket 1 faces in opposite direction. This type of mounting is also called “top venting”, since the sound propagates from the membrane 15 (arranged in the region of the top side of the basket) directly towards a sound opening in the platform 3.

As already mentioned above the mounting structures 6, 7 of the basket 1 include contact surfaces. As depicted in FIG. 5, the corresponding mounting structures 8, 9 of the platform 3 each includes an electrically conducting spring 13, wherein the spring 13 engages a contact surface, which is arranged in a recess of the side wall of the basket 1.

In both embodiments, the platform 3 includes mounting structures 8, 9 cooperating with the mounting structures 6, 7 of the basket 1, thereby forming a mounting mechanism in form of a clip mechanism that provides a fixed mechanical connection between basket 1 and platform 3. The electrical contact areas 11, 12 of the platform 3 are integrally formed with the mounting structures 8, 9 of the platform 3, such that an electrical connection between the electrical contact areas 4, 5 of the basket 1 and the electrical contact areas 11, 12 of the platform 3 is established via the mounting mechanism. In other words, the basket-sided and the platform-sided electrical contacts areas 4, 5, 11, 12 engage with each other when the mounting structures form a fixed mechanical connection between basket 1 and platform 3.

In the preferred embodiments depicted in FIGS. 3-6, the mounting mechanism is configured such, that the basket 1 is pressed against the platform 3. A sealing gasket 16 is arranged between basket 1 and platform 3, the gasket preferably being pressed between basket 1 and platform 3 by the force applied by cooperating mounting structures. The gasket 16 seals the basket 1 and/or the transducer 2 against the platform 3.

In a further embodiment, a mesh may be provided with the sealing gasket 16, this mesh covering the membrane 15. In a further preferred embodiment, the back side of the acoustic transducer 2 may also be covered by a mesh.

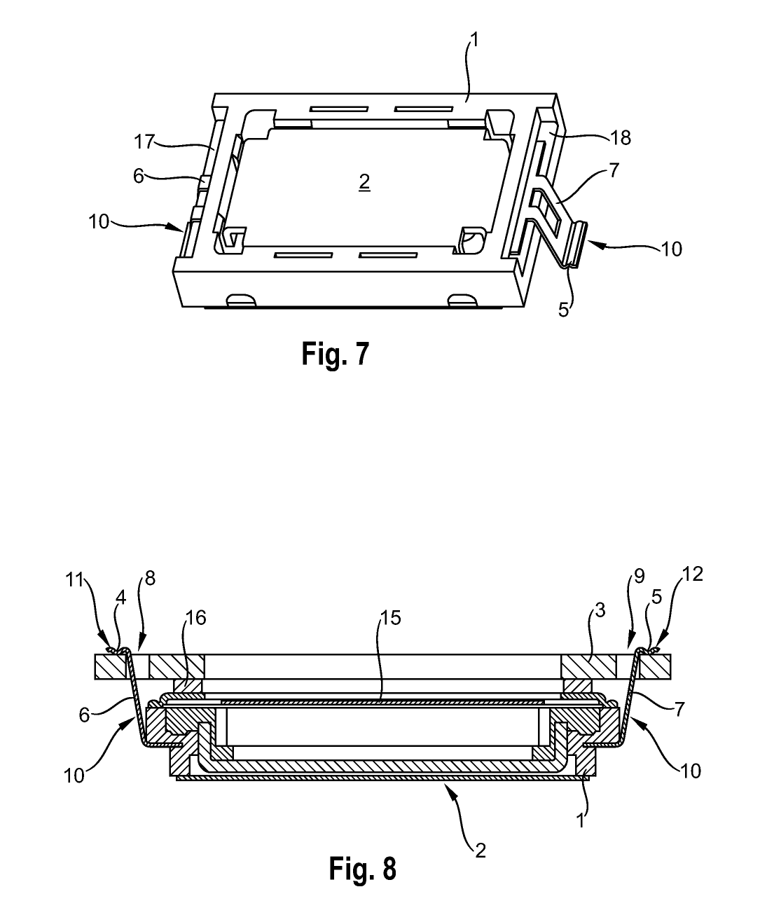

FIGS. 7 and 8 depict yet a further embodiment. Here, the basket-sided mounting structures 6, 7 are formed by springs 10 in form of clip springs projecting from the basket 1. As may be seen from the mounted state of FIG. 8, the springs 10 project from the basket 1 towards the platform 3 and cooperate with the platform-sided mounting structures 11, 12, which, in the present embodiment are each formed by an opening in the platform 3. The springs 10 may be formed integrally with the basket body. They may be comprised from a molded plastic which is covered with a metal plating.

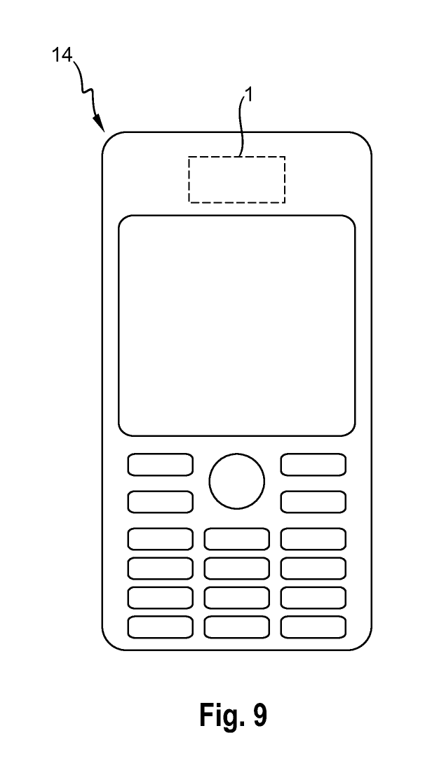

Finally, FIG. 9 depicts a communication device in form of a cellular phone 14 including an acoustic transducer assembly according to the invention.

The invention is not limited to the exemplary embodiments depicted. For example, the design of the basket may be chosen as of different kind (for example, circular, rectangular, etc.). The plating processes and the metals employed are not merely limited to the exemplary explicitly described embodiments, but instead should be understood in a wider context. The electrical contact areas may be differently located. Likewise, the respective numbers of first and second electrical contact areas is not restricted to the exemplary embodiments depicted. Furthermore, the number of electrical contact areas facing to the top side of the basket and the number of electrical contact areas facing to the bottom side of the basket may differ from the exemplary embodiments described above.

It should be understood that it would also be possible to provide a combination of at least one passive mounting structure and at least one active mounting structure on the basket. For example, on one side wall of the basket there would be a spring, and on the other side wall of the basket a contact surface, or vice versa. The platform would have complementary mounting structures.

The dimensions of the basket are correspondingly adapted to the dimensions of the acoustic transducers used. As an example, and in a preferred embodiment for use in communication devices, particularly in cellular phones, the length of the basket may be smaller than 30 mm, more preferably smaller than 20 mm, most preferably smaller than or equal to 15 mm.

In closing, it should be noted that the invention is not limited to the above mentioned embodiments and exemplary working examples. Further developments, modifications and combinations are also within the scope of the patent claims and are placed in the possession of the person skilled in the art from the above disclosure. Accordingly, the techniques and structures described and illustrated herein should be understood to be illustrative and exemplary, and not limiting upon the scope of the present invention. The scope of the present invention is defined by the appended claims, including known equivalents and unforeseeable equivalents at the time of filing of this application.

What is claimed is:

1. An acoustic transducer basket comprising:
a basket configured to receive an acoustic transducer, the basket comprising:
at least one basket mounting structure configured to mechanically attach the basket to a platform; and
a plurality of electrical contact areas configured to electrically connect the basket to the platform;
wherein at least one of the electrical contact areas is integrally formed with the basket mounting structure.

2. The acoustic transducer basket of claim 1, wherein the basket further comprises:
at least two basket mounting structures;
a first electrical contact area of the plurality of electrical contact areas, the first electrical contact area integrally formed with a first one of the at least two basket mounting structures; and
a second electrical contact area of the plurality of electrical contact areas, the second electrical contact area integrally formed with a second one of the at least two basket mounting structures.

3. The acoustic transducer basket of claim 2, wherein the basket further comprises:
a first basket side wall, the first one of the at least two basket mounting structures being arranged on the first basket side wall; and
a second basket side wall, the second one of the at least two basket mounting structures being arranged on the second basket side wall.

4. The acoustic transducer basket of claim 3, wherein the basket further comprises:
a third basket mounting structure arranged on the first basket side wall, the third basket mounting structure being laterally spaced from the first one of the at least two basket mounting structures that is arranged on the first basket side wall; and
a fourth basket mounting structure arranged on the second basket side wall, the fourth basket mounting structure being laterally spaced from the second one of the at least two basket mounting structures that is arranged on the second basket side wall.

5. The acoustic transducer basket of claim 1, wherein at least one of the electrical contact areas forms a surface on the at least one basket mounting structure, the at least one electrical contact area being made from a metal plating.

6. The acoustic transducer basket of claim 1, wherein the basket further comprises:
a basket wall; and
a piece of metal attached to the basket wall to form one of the plurality of electrical contact areas.

7. The acoustic transducer basket of claim 1, wherein at least one of the plurality of electrical contact areas comprises a contact pad of electrically-conducting material formed on the at least one basket mounting structure and configured to engage an electrical contact surface located on a platform when the acoustic transducer basket is mounted on the platform.

8. The acoustic transducer basket of claim 7, wherein the basket further comprises a side wall, the basket side wall having a recess, wherein the contact surface is arranged in the recess.

9. The acoustic transducer basket of claim 1, wherein the basket further comprises a basket wall and wherein the at least one mounting structure comprises a lateral projection that projects laterally from the basket wall.

10. The acoustic transducer basket of claim 1, wherein the basket further comprises:
at least one basket side wall, the at least one basket side wall having at least two of the plurality of electrical contact areas provided thereon;
a first of the at least two from the plurality of electrical contact areas facing towards a basket top side; and
a second of the at least two from the plurality of electrical contact areas facing towards a basket bottom side;
wherein one of the at least two from the plurality of electrical contact areas being formed on a lateral projection of the at least one basket side wall, while another of the at least two from the plurality of electrical contact areas being formed on a recess of the at least one basket side wall.

11. The acoustic transducer basket of claim 1, wherein the basket further comprises:
at least one basket side wall; and
at least two from the plurality of electrical contact areas being arranged on the at least one basket side wall and being electrically interconnected for common electrical assignment.

12. The acoustic transducer basket of claim 1, further comprising a spring configured to project from the basket and forming the at least one mounting structure.

13. The acoustic transducer basket as claimed in claim 12, wherein the spring is a clip spring.

14. An acoustic transducer assembly comprising:
a platform;
a platform mounting structure on the platform;
an acoustic transducer basket, the acoustic transducer basket having a basket mounting structure;
the basket mounting structure cooperating with the platform mounting structure to together form a mounting mechanism that provides a fixed mechanical connection between the basket and the platform;
an electrical contact area of the platform, the electrical contact area of the platform being formed integrally with the platform mounting structure;
an electrical contact area on the basket; and
the mounting mechanism providing an electrical connection between the electrical contact area of the platform and the electrical contact area of the basket.

15. The acoustic transducer assembly of claim 14, wherein the mounting mechanism is configured to press the basket against the platform.

16. The acoustic transducer assembly of claim 14, wherein the basket mounting structure includes a contact surface, wherein the platform mounting structure includes an electrically conducting spring configured to engage the contact surface.

17. The acoustic transducer assembly of claim 14, further comprising:
a basket wall;
the basket mounting structure having at least two lateral projections that project laterally from the basket wall; and
the platform mounting structure including a bracket-shaped spring, the bracket-shaped spring having two ends, each of the two ends respectively engaging with a respective one of the at least two lateral projections.

18. The acoustic transducer assembly of claim 14, wherein the basket mounting structure includes at least one spring projecting from the basket towards the platform, wherein the platform mounting structure fixes the spring in a clipped state.

19. The acoustic transducer assembly of claim 18, wherein the spring is a clip spring.

20. The acoustic transducer assembly as claimed in claim 18, wherein the platform is configured for incorporation into a cellular phone.
